(19) United States
(12) Patent Application Publication
(10) Pub. No.: US 2006/0023915 A1
(43) Pub. Date: Feb. 2, 2006

(54) System and method for presence detection

(76) Inventors: Lars Erik Aalbu, Oslo (NO); Tom-Ivar Johansen, Oslo (NO)

Correspondence Address: CHRISTIAN D. ABEL, ONSAGERS AS, POSTBOKS 6963 ST. OLAVS PLASS, NORWAY, N-0130, NO

(21) Appl. No.: 11/146,055

(22) Filed: Jun. 7, 2005

(30) Foreign Application Priority Data
Jun. 9, 2004 (NO) 20042409

(51) Int. Cl. G06K 9/00

(52) U.S. Cl. 382/103

(57) ABSTRACT

THE present invention discloses a system and method for automatically detecting the presence of a user in a presence application connected to a video conference endpoint. The presence detection is provided by active detection mechanisms monitoring the localities near the endpoint or terminal connected to the application. The presence information is centrally stores in a presence server collecting the information directly from the respective user terminals. According to preferred embodiments of the present invention, presence is determined by means of radar detection, infrared light detection, motion search in the video processing to the codec in the and face detection/recognition.

### FIELD OF THE INVENTION

The present invention relates to presence detection in presence applications.

### BACKGROUND OF THE INVENTION

Conventional conferencing systems comprise a number of endpoints communicating real-time video, audio and/or data streams over and between various networks such as WAN, LAN and circuit switched networks.

Conferencing equipment is now widely adopted, not only as a communication tool, but also as a tool of collaboration, which involves sharing of e.g. applications and documents. To make collaborative activities through conferencing as efficient as other types of team work, it is essential to instantly get hold of colleagues, customers, partners and other business connections as if they were next to you. Instant Messaging and presence application provides this in some degree when connected to conferencing applications.

The patent application NO 2003 2859 discloses a presence/Instant Messaging system connected to scheduling and accomplishment of a conference. Presence and IM applications are known as applications indicating whether someone or something is present or not. A so-called “buddy list” on a user terminal shows the presence of the people or systems (buddies) that have been added to the list. The list indicates if the “buddy” is present or not (logged on the computer, working, available, idle, or another status) by a symbol next to the respective “buddies”. The “buddies” can also be connected to a preferred conferencing endpoint (or a list of preferred endpoints in a prioritized order), which is indicated by a different symbol. For example, a red camera symbol indicates that the preferred endpoint of a “buddy” is busy, and a green camera symbol indicates that it is idle and ready to receive video calls. IM and presence applications are usually provided through a central presence server storing user profiles, buddy lists and current presence status for the respective users. The presence functionality creates a feeling of presence also with people or objects that are located in other buildings, towns, or countries.

By connecting a presence application to the endpoints or Management system of a conferencing system, a first user will be able to see when a second user is present (not busy with something else), and at the same time, an idle conferencing system may be selected according to the priority list of the second user. This will provide a new ad-hoc possibility to common resources, as unnecessary calls (due to ignorance of presence information) will be avoided and manual negotiations through alternative communication prior to the call will not be required. A double click on a “buddy” in a “buddy list” may e.g. execute an immediate initiation of a call to the “buddy” using the most preferred idle system associated with the “buddy”. In the case where conferencing endpoints are connected to IM or presence applications, the presence server is usually connected to a conference managing system providing status information of the endpoints respectively associated with the users of the presence application.

In conventional IM and presence applications, presence is determined by detecting activities on the user's terminal. If a user of such an application is defined as “not present”, the status is changed to “present” when some user input is detected, e.g. moving the mouse or striking a key on the terminal keyboard. The status remains “present” in some predefined time interval from last detected user input signal. However, if this time interval expires, without any activities being detected, the status is changed back to “not present”.

This presence determination works properly provided that the user touches some of the terminal input devices continuously or at regular intervals. Activities other than those involving typing on the keyboard or moving the mouse are not detected by the IM or presence application. In fact, the user may still be present, e.g. reading a document printout, which is an activity not requiring terminal input signals.

On the other hand, the IM or presence application could also indicate that the user is present when he/she in reality is not. This situation will occur when the user leaves the room or seat before the predefined time interval has expired. Setting the time interval will always be a trade off between minimization of these two problems, but they can never be eliminated in a presence application based on terminal input detection only.

Some of the drawbacks of the passive presence detection described above are partly solved by other active presence detection, some of which are described in the following.

There are several ways of discovering and monitoring movements and human presence in a limited area of detection. One example is motion detection by means of radar signals. A radar transceiver positioned close to the user terminal sends out bursts of microwave radio energy (or ultrasonic sound waves), and then waits for the reflected energy to bounce back. If there is nobody in the area of detection, the radio energy will bounce back in a known pre-measured pattern. This situation is illustrated in FIG. 2. However, if somebody enters the area, the reflection pattern is disturbed. As shown in FIG. 3, the person entering the area will create a reflection shadow in the received radar pattern. When this differently distributed reflection pattern is detected, the transceiver sends a signal to the presence server indicating that the user status is changed from “not present” to “present”.

This technology is widely being used in connection with e.g. door openers and alarm systems. However, as opposed to presence applications, these types of applications require one-time indications only for executing a specific action. Presence applications need to provide continuous information. To consider this, the reflected pattern is always compared to the last measured pattern instead of a predefined static pattern. Alternatively, the parameter indicating presence can be derived from the time derivative of the reflected pattern. As for traditional presence detection, a time interval will also be necessary for allowing temporary static situations. As an example, if said time interval is set to 10 sec., the presence application will assume that the user is present for ten seconds after last change in measured reflected pattern, but when the time interval has expired, presence status is changed from “present” to “not present”. In the case of motion detection, the time intervals could be substantially smaller than for prior art presence detection based on user input detection, as it is reasonably to assume that general movements will occur more often than user inputs on a terminal.

An alternative presence detector design is a passive infrared (PIR) motion detector. These sensors “see” the infrared energy emitted by a human's body heat. In order to make a sensor that can detect a human being, it has to be made sensitive to the temperature of a human body. Humans having a skin temperature of about 34° C., radiate infrared energy with a wavelength between 9 and 10 micrometers. Therefore, the sensors are typically sensitive in the range of 8 to 12 micrometers

The devices themselves are simple electronic components not unlike a photo sensor. The infrared light bumps electrons off a substrate, and these electrons can be detected and amplified into a signal indicating human presence

Even if the sensors measure temperatures of a human being, conventional PIRs are still motion detectors because the electronics package attached to the sensor is looking for a rapid change in the amount of infrared energy it is seeing. When a person walks by or moves a limb, the amount of infrared energy in the field of view changes rapidly and is easily detected

Motion sensing light has a wide field of view because of the lens covering the sensor. Infrared energy is a form of light, allowed for focusing and bending with a plastic lens.

Because PIRs usually detect changes in infrared energy, a time interval will also in this case be necessary for allowing temporary static situations, as for radar motion detection.

FIG. 4 shows an example of an arrangement of a presence application including a presence sensor e.g. of the one described above. The presence sensor is placed on top of the user terminal, providing a detection area in front of which. Connected to the presence sensor is a presence sensor processing unit, which also can be an integrated part of the user terminal, controlling and interpreting the signals from the presence sensor. In case of a radar sensor, the reflection patterns to which current reflection patterns should be compared, is stored in the unit. In case of a PIR, it will store the minimum rate of change in infrared energy for the signals to be interpreted as caused by movements. In both cases, the above discussed time intervals will also be stored, and based on the stored data and the incoming signals, the unit determines whether a change of presence status has occurred or not. If so, this is communicated to the presence server, which in turn updates the presence status of the user. This arrangement allows for use of different types of presence detection for users in the same buddy list, as the presence server does not have to be aware of how information of change in presence status is provided.

One of the problems of the above-described solutions is that all of them require add-on equipment for the presence detection. Thus, there is a need for a solution providing an improved presence detection utilising existing devices and processes incorporated in a conventional video conference system.

### SUMMARY OF THE INVENTION

It is an object of the present invention to provide a system and method avoiding the above-described problems.

The features defined in the independent claims enclosed characterize this system and method.

In particular, the present invention provides a system adjusted to detect presence and absence of a user near a video conference endpoint connected to a camera, a codec and a microphone associated with the user in a presence application providing status information about the user to other presence application users through a presence server configured to store information about current operative status of the endpoint and associating the user with the video conference endpoint, wherein the system further includes a presence detector configured to automatically switch the operative status between present mode and absent mode wherein switching from absent mode to present mode appears when a motion search included in a coding process implemented in the codec detects more than a predefined number of motion vectors at a predefined size in a video view captured by the camera, and switching from present mode to absent mode appears when said motion search included in the coding process implemented in the codec detects less than said predefined number of motion vectors at the predefined size in a video view captured by the camera.

### BRIEF DESCRIPTION OF THE DRAWINGS

In order to make the invention more readily understandable, the discussion that follows will be supported by the accompanying drawings,

FIG. 1 illustrates a principal architecture of a conferencing system connected to a presence application,

FIGS. 2 and 3 is a top view of a room with a radar presence detector indicating the radar pattern,

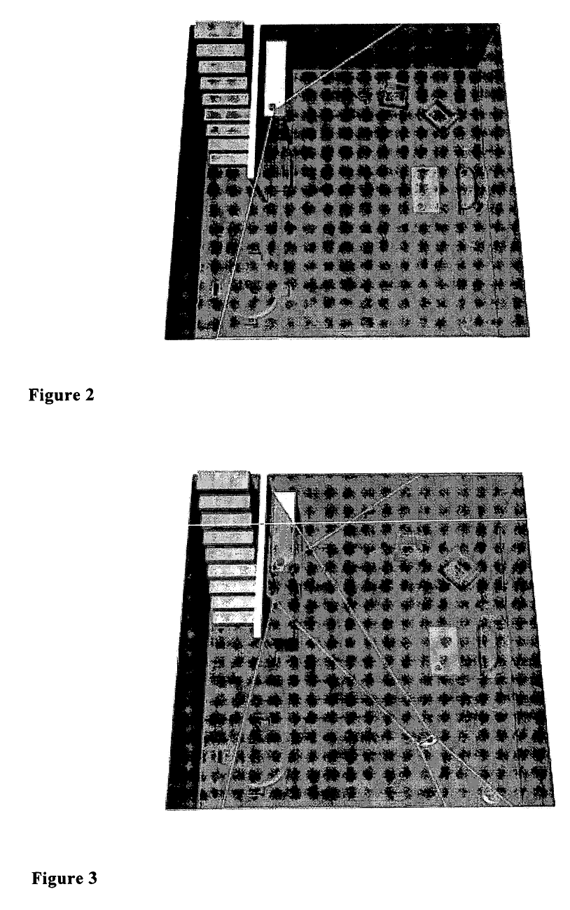

FIG. 4 shows a presence sensor processing unit connected to a presence server and a presence detector with the associated area of detection.

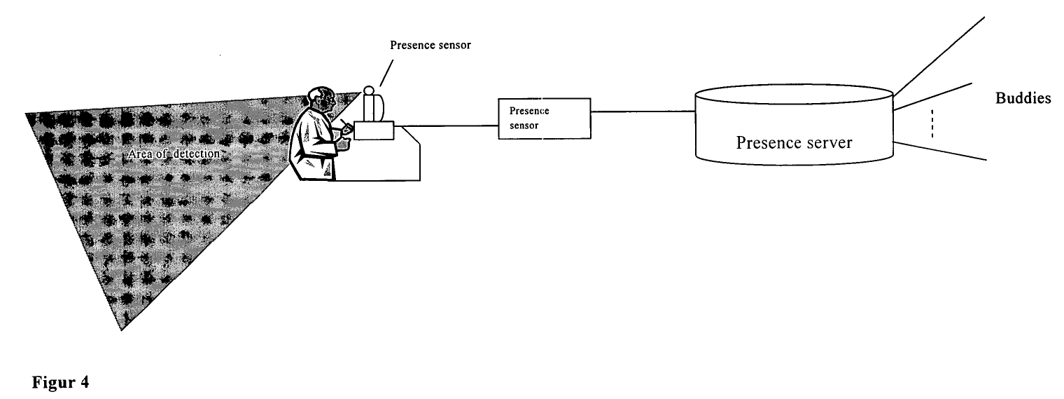

### BEST MODE OF CARRYING OUT THE INVENTION

In the following, the present invention will be discussed by describing preferred embodiments, and supported by the accompanying drawings. However, people skilled in the art will realize other applications and modifications within the scope of the invention as defined in the enclosed independent claims.

According to the present invention, the presence detection in presence and IM applications is provided by active detection mechanisms monitoring the localities near the end-point or terminal connected to the application. This will provide a more reliable and user-friendly presence detection than present systems.

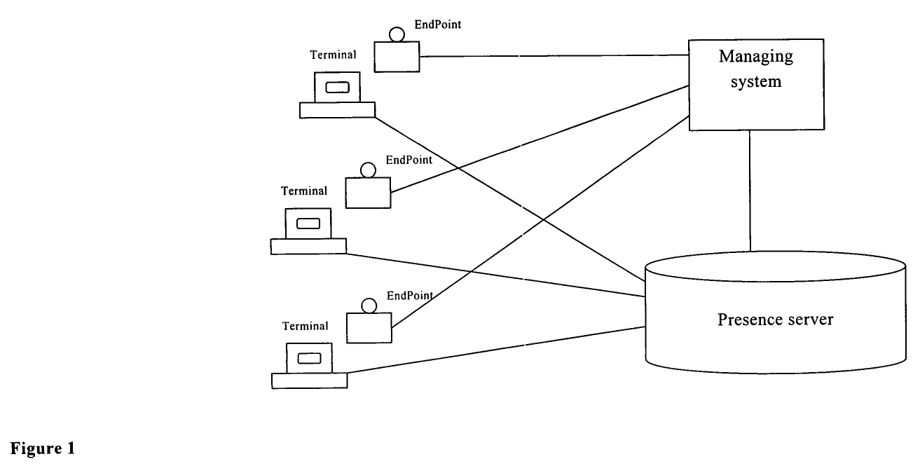

Traditionally, presence applications connected to conferencing are arranged as illustrated in FIG. 1. The presence information is centrally stored in a presence server collecting the information directly from the respective user terminals. Status information of the endpoints associated with the user terminals is also stored in the presence server, but provided via a conference managing system, which in turn is connected to the endpoints.

According to a preferred embodiment of the present invention, the presence detection is implemented by utilising motion search of the video view captured by the video endpoint, which is an already existing process in the codec of a video conference endpoint.

In video compression processes, the main goal is to represent the video information with as little capacity as possible. Capacity is defined with bits, either as a constant value or as bits/time unit. In both cases, the main goal is to reduce the number of bits.

The most common video coding method is described in the MPEG* and H.26* standards, all of which using block based prediction from previously encoded and decoded pictures.

The video data undergo four main processes before transmission, namely prediction, transformation, quantization and entropy coding.

The prediction process significantly reduces the amount of bits required for each picture in a video sequence to be transferred. It takes advantage of the similarity of parts of the sequence with other parts of the sequence. Since the predictor part is known to both encoder and decoder, only the difference has to be transferred. This difference typically requires much less capacity for its representation. The prediction is mainly based on picture content from previously reconstructed pictures where the location of the content is defined by motion vectors.

In a typical video sequence, the content of a present block M would be similar to a corresponding block in a previously decoded picture. If no changes have occurred since the previously decoded picture, the content of M would be equal to a block of the same location in the previously decoded picture. In other cases, an object in the picture may have been moved so that the content of M is more equal to a block of a different location in the previously decoded picture. Such movements are represented by motion vectors (V). As an example, a motion vector of (3; 4) means that the content of M has moved 3 pixels to the left and 4 pixels upwards since the previously decoded picture.

A motion vector associated with a block is determined by executing a motion search. The search is carried out by consecutively comparing the content of the block with blocks in previous pictures of different spatial offsets. The offset relative to the present block associated with the comparison block having the best match compared with the present block, is determined to be the associated motion vector.

In prior art solutions, it has been assumed that an extra sensor device is added to the client equipment. However, in a video conferencing application, there are already installations and processes, which include information about changes in the nearby environment, e.g. the motion search process discussed above. A proper interpretation of this information could provide some of the same presence information as when using an additional sensor, without requiring extra hardware.

As already indicated, the codec associated to a video conferencing endpoint is already configured to detect changes in the view captured by the camera by comparing current picture with the previous ones, because a more effective data compression is achieved by coding and transmitting only the changes of the contents in the captured view instead of coding and transmitting the total content of each video picture. As an example, coding algorithms according to ITU's H.263 and H.264 execute a so-called motion search in the pictures for each picture block to be coded. The method assumes that if a movement occurs in the view captured by the camera near the picture area represented by a first block of pixels, the block with the corresponding content in the previous picture will have a different spatial position within the view. This “offset” of the block relative to the previous picture is represented by a motion vector with a horizontal and a vertical component.

By continuously investigating the presence of non-zero motion vectors associated with a coded video stream, movements in the camera view will be detectable. However, there is no need for a complete coding of the camera-captured view when the endpoint is not transmitting. Thus, in idle state, a limited coding process is switched on, including the above described motion search only. The presence sensor processing unit will then be connected to the codec of the video conferencing endpoint, and may be instructed to interpret that if the number of motion vectors is more than a certain threshold, a change of presence status from “not present” to “present” is communicated to the presence server.

The disadvantage of presence detection solely based on motion vectors is that it is a two-dimensional detection, which may result in incorrect presence detections e.g. when the camera captures movements outside a window. These kinds of errors will rarely occur when using radar detection or PIR as both are associated with a three-dimensional detection area.

According to one embodiment of the present invention, this problem is avoided by combining motion vector movement detection with face detection. Face detection is normally used to distinguish human faces (or bodies) from the background of an image in connection with face recognition and biometric identification. By starting a face detecting process only when movements are detected in the view, it will not be necessary to expose the video image for continuous face detection, which is relatively resource-demanding. Further, presence detection including face detection will be more reliable than presence detection based on motion vectors only.

Face detection is normally carried out based on Markov Random Field (MRF) models. MRFs are viable stochastic models for the spatial distribution of gray level intensities for images of human faces. These models are trained using databases of face and non-face images. The MRF models are then used for detecting human faces in sample images.

A sample image is assumed including a face if the log pseudo likelihood ratio (LPR) of face to non-face,

$$LPR = {\sum }_{s = 1}^{\# S} log ( \frac{{\hat{p}}_{face} ( {x}_{s}^{inp} \vert {x}_{- s}^{inp} )}{{\hat{p}}_{non face} ( {x}_{s}^{inp} \vert {x}_{{π}^{s}}^{inp} )} ) > 0$$

Otherwise, the test image will be classified as a nonface. The equation makes a comparison of the function representing the probability of a face occurring in the sample image with the function representing the probability of a face not occurring in the sample image, given the gray level intensities of all the pixels. In the equations, s={1, 2, . . . , #S} denotes the collection of all pixels in the image. \hat{p}_{face/non face}(·|·) stands for the estimated value of the local characteristics at each pixel based on the face and non-face training data bases, respectively. xₛ^{inp} is the gray level at the respective pixel positions, and x₋ₛ^{inp} is the gray level intensities of all pixels in S excluding the respective pixel position. The definition of p is described in details e.g. in “Face Detection and Synthesis Using Markov Random Field Models” by Sarat C. Dass, Michigan State University, 2002. pface and pnonface is “trained” by two sets of images, respectively including and not including faces, by seeking the maximum pseudolikelihood of p with respect to a number of constants in the expression of p. Consequently, the “training” implies finding an optimal set of constants for p, respectively associated with occurrence and non-occurrence of a face in a picture.

According to one embodiment of the present invention, the presence sensor processing unit initiates execution of the LPR-test depicted above on current images when a certain number or amount of motion vectors are detected. If LPR is substantially greater than zero in one or more successive sample images, the presence sensor processing unit assumes that the user is present and communicates a change in presence status from “not present” to “present”. When in present state, the presence sensor processing unit keeps on testing the presence of a human face at regular intervals provided that motion vector also is present. When the LPR-test indicates no human face within the captured view, the presence sensor processing unit communicates a change in presence status from “present” to “not present” to the presence server, which also will be the case when no or minimal motion vectors occurs in a certain predefined time interval.

As already mentioned, face detection is the first step in face recognition and biometric identification. Face recognition requires a much more sophisticated and processor-consuming methods compared to face detection only. However, face recognition in presence detection will provide a far more reliable detection, as face detection only states that contours of a face exits within the view, but not the identity of the face. Thus, one embodiment of the invention also includes face recognition as a part of the presence detection.

When face occurrence in the view is detected as described above, an algorithm searching for face contours starts processing the sample image. The algorithm starts by analyzing the image for detecting edge boundaries. Edge boundary detection utilizes e.g. contour integration of curves to search for the maximum in the blurred partial derivative.

Once a face is isolated, the presence sensor processing unit determines the head's position, size and pose. A face normally needs to be turned at least 35 degrees toward the camera for the system to register it. The image of the head is scaled and rotated so that it can be registered and mapped into an appropriate size and pose. This normalization is performed regardless of the head's location and distance from the camera.

Further, the face features are identified and measured providing a number of facial data like distance between eyes, width of nose, depth of eye sockets, cheekbones, jaw line and chin. These data are translated into a code. This coding process allows for easier comparison of the acquired facial data to stored facial data. The acquired facial data is then compared to a pre-stored unique code representing the user of the terminal/endpoint. If the comparison results in a match, the presence sensor processing unit communicates to the presence server to change the present status from “not present” to “present”. Subsequently, the recognition process is repeated at regular intervals, and in case no match is found, the presence sensor processing unit communicates to the presence server to change the presence status from “present” to “not present”.

So far, we have only discussed methods of presence detection. In some cases it is not sufficient to know whether a “buddy” in a “buddy list” is present or not. It may be just as important to detect if the “buddy” is not ready for receiving calls or requests, i.e. present but still busy. This is solved in the presence application of prior art by allowing the user to manually notify whether he/she is busy or not. As an example, in the presence application MSN Messenger, it is possible to set own status to i.a. “Busy”, “On the phone” and “Out to lunch”. This is not reliable for all instant situations as when having ad hoc meeting in the office.

In one embodiment of the present invention, this is solved by also connecting the microphone of the endpoint to the presence sensor processing unit. When audio, preferably audio from a human voice, above a certain threshold is received by the unit for a certain time interval, it assumes that the user is engaged in something else, e.g. a meeting or a visit, and the presence status is changed from “present” to “busy” Opposite, when silence has occurred for a certain time interval, and the other criterions for presence also is detected, the presence status is changed from “not present” to “present”.

An alternative to this broadened presence feature is that the “buddies” of a user are given permission to observe a snapshot regularly captured by the camera of the user associated endpoint. Out of the consideration of privacy protection and security, the snapshots should be stored at the user side, e.g. in the user terminal or in the presence sensor processing unit. Only at a request from one of the user's “buddies”, the snapshot is transmitted, either encrypted or on a secure connection to the request originator. This will be a parallel to throwing a glance through someone's office window to check whether he/she seems to be ready for visits.

1. A system for detecting presence and absence of a user near a video conference endpoint connected to a camera, a codec and a microphone associated with the user in a presence application providing status information about the user to other presence application users through a presence server,
characterized in
a presence detector configured to automatically switch the operative status between present mode and absent mode wherein switching from absent mode to present mode appears when a motion search included in a coding process implemented in the codec detects more than a predefined number of motion vectors at a predefined size in a video view captured by the camera, and switching from present mode to absent mode appears when said motion search included in the coding process implemented in the codec detects less than said predefined number of motion vectors at the predefined size in a video view captured by the camera.

2. A system according to claim 1, characterized in that said presence detector includes a face detection process adapted to detect a face in said captured video view, said presence detector is further adapted to switching from absent mode to present mode only when a face is detected, and switching from present mode to absent mode if a face is not detected.

3. A system according to claim 2, characterized in that said presence detector further includes a face recognition process adapted to isolate said face detected by the face detection process and to extract certain characteristics of the face from which a first code representing the face is calculated, said presence detector is further configured to compare said first code with a pre-stored second code representing a face of the user.

4. A system according to one of the claims 1-3,
characterized in that said presence detector is configured to state that the user is in a busy status when voice captured by said microphone is detected.

5. A system according to one of claims 1-3,
characterized in that the camera regularly capturing a snapshot of the video view, said presence detector is configured to store said snapshot and make them available for a selection of the other presence application users by request.

6-19. (canceled)

20. A method of detecting presence and absence of a user near a video conference endpoint connected to a camera and a codec associated with the user in a presence application providing status information about the user to other presence application users through a presence server configured to store information about current operative status of the endpoint and associating the user with the video conference endpoint, characterized in the steps of:
switching the operative status from absent mode to present mode when a motion search included in a coding process implemented in the codec detects more than a predefined number of motion vectors at a predefined size in a video view captured by the camera, and
switching the operative status from present mode to absent mode when said motion search included in the coding process implemented in the codec detects less than said predefined number of motion vectors at said predefined size in said video view captured by the camera providing information to the presence server whether the user is absent or present, regularly, at request or at the time of transition between absence and presence.

21. A method according to claim 20, characterized in the steps of:
storing information about current operative status of the video conference endpoint,
associating the user with the video conference endpoint.

22. A method according to claim 20 or 21, characterized i n the steps of:
executing a face detection process on said video view, executing the step of switching the operative status from absent mode to present mode only when a face within said video view is detected, and
executing the step of switching the operative status from present mode to absent mode only when no face within said video view is detected.

23. A method according to claim 22, characterized i n that the steps of executing further includes:
executing a face recognition process if a face is detected by said face detection process,
extracting certain characteristics of the face from which a first code representing the face is calculated,
comparing said first code with a pre-stored second code representing a face of the user,
stating that a face is detected when said first code equals said second code, stating that no face is detected when said first code not equals said second code.
